(19) United States
(12) Patent Application Publication
(10) Pub. No.: US 2009/0081153 A1
(43) Pub. Date: Mar. 26, 2009

(54) COMBINATION OF SYNTHETIC ANTIMICROBIAL POLYMERS AND SESQUITERPENOID COMPOUNDS

(75) Inventors: Richard W. Scott, Radnor, PA (US); Byron F. Brehm-Stecher, Ames, IA (US)

Correspondence Address: Pepper Hamilton LLP, 400 Berwyn Park, 899 Cassatt Road, Berwyn, PA, 19312-1183, US

(73) Assignee: POLYMEDIX, INC., Radnor, PA (US)

(21) Appl. No.: 12/191,601

(22) Filed: Aug. 14, 2008

Related U.S. Application Data
(60) Provisional application No. 60/956,649, filed on Aug. 17, 2007.

(51) Int. Cl. A01N 37/00; A01P 1/00

(52) U.S. Cl. 424/78.31; 424/78.08

(57) ABSTRACT

The present invention provides compositions comprising a synthetic antimicrobial polymer and/or oligomer and a sesquiterpenoid compound useful in reducing the growth of microbes.

### CROSS-REFERENCE TO RELATED APPLICATIONS

This application claims priority to U.S. provisional application Ser. No. 60/956,649 filed Aug. 17, 2008, which is incorporated herein by reference in its entirety.

### FIELD OF THE INVENTION

The present invention is directed, in part, to compositions comprising a synthetic antimicrobial polymer and/or oligomer and a sesquiterpenoid compound, and to methods of reducing microbial growth by contacting a microbe with such a composition.

### BACKGROUND OF THE INVENTION

Synthetic antimicrobial polymers have been utilized in preparing chemical disinfectants and biocides (Tashiro, Macromol. Mater. Eng., 2001, 286, 63-87). Several polymeric disinfectants have been prepared using conventional synthetic polymers including, for example, poly(vinylpyridine)s (Tiller et al., Proc. Natl. Acad. Sci. U.S.A., 2001, 98, 5981-5985), poly(vinylalcohol)s (Baudrion et al., J. Appl. Polym. Sci., 1998, 70, 2657-2666), polyacrylates (Kenawy et al., J. Controlled Release, 1998, 50, 145-152), and polystyrenes (Gelman et al., Org. Lett., 2004, 6, 557-560). Additional synthetic antimicrobial polymers that are not toxic to mammalian cells have been recently reported and include, for example, free radical copolymerizations of N-(tert-butoxycarbonyl)aminoethyl methacrylate and butyl methacrylate (BMA) conducted using mole percentages of BMA from 0 to 60% in the presence of methyl 3-mercaptopropionate (MMP) to give a precursor polymer protected with tert-butoxycarbonyl (Boc) groups, and subsequent treatment of the Boc-protected polymer with TFA to afford desired cationic random copolymer (Kuroda et al., J. Am. Chem. Soc., 2005, 127, 4128-4129). The amphiphilic structures of these polymers disrupt cell membranes, cause breakdown of the transmembrane potential and leakage of cytoplasmic contents, thereby ultimately resulting in cell death.

What is needed are methods and compositions to make the antimicrobial activity of the synthetic antimicrobial polymers and/or oligomers even more effective by, for example, reducing the amount of synthetic antimicrobial polymer and/or oligomer required to achieve a satisfactory reduction in microbial growth.

### SUMMARY OF THE INVENTION

The present invention provides antimicrobial compositions comprising: one or more synthetic antimicrobial polymers and/or oligomers; one or more sesquiterpenoid compounds; and a carrier. In some embodiments, the carrier is selected from water, ethanol, and propylene glycol. In other embodiments, the carrier is a pharmaceutically acceptable carrier.

In some embodiment, the synthetic antimicrobial polymers and/or oligomers of the invention are selected from a compound of formula A-(B)ₙ-(D)ₘ-H, or an acceptable salt or solvate thereof, wherein:

A is the residue of a chain transfer agent;

B is —[CH₂—C(R¹¹)(B₁₁)]—, wherein B₁₁ is -X₁₁-Y₁₁-Z₁₁, and

X₁₁ is carbonyl or optionally substituted C₁₋₆ alkylene; or X₁₁ is absent;

Y₁₁ is O, NH, or optionally substituted C₁₋₆ alkylene; or Y₁₁ is absent;

Z₁₁ is Z_{11A}-Z_{IIB}, wherein:

Z_{11A} is alkylene, arylene, or heteroarylene, any of which is optionally substituted; or Z_{11A} is absent;

Z_{11B} is -guanidino, -amindino, —N(R³)(R⁴) or —N+(R³)(R⁴)(R⁵), wherein R³, R⁴, and R⁵, are independently hydrogen, alkyl, aminoalkyl, aryl, heteroaryl, heterocyclic, or aralkyl;

D is —[CH₂—C(R²¹)(D₂₁)]-, wherein D₂₁ is -X₂₁-Y₂₁-Z₂₁, and

X₂₁ is carbonyl or optionally substituted C₁₋₆ alkylene; or X₂₁ is absent;

Y₂₁ is O, NH, or optionally substituted C₁₋₆ alkylene; or Y₂₁ is absent;

Z₂₁ is alkyl, cycloakyl, alkoxy, aryl, or aralkyl, any of which is optionally substituted;

R¹¹ and R²¹ are independently hydrogen or C₁₋₄ alkyl;

m, the mole fraction of D monomer, is about 0.1 to about 0.9; and

n, the mole fraction of B monomer is 1-m;

wherein the compound is a copolymer of B and D monomers.

In some embodiments of the invention, the synthetic antimicrobial polymers and/or oligomers are selected from polymethcrylates. In some embodiments of the invention, the synthetic antimicrobial polymers and/or oligomers are selected from polymethcrylates that comprise a first monomer and a second monomers; wherein said first monomer comprises amino-ethyl methacrylate and said second monomer comprises butyl-methacrylate, ethyl-methacrylate, or methyl-methacrylate. In some embodiments of the invention, the synthetic antimicrobial polymers and/or oligomers are selected from polymer A (hereinafter “Compound A” and provided below), polymer B (hereinafter “Compound B” and provided below), polymer C (hereinafter “Compound C” and provided below), polymer D (hereinafter “Compound D” and provided below), or a mixture thereof. In one embodiment, the synthetic antimicrobial polymers and/or oligomers compounds of the invention comprise Compound A. In one embodiment, the synthetic antimicrobial polymers and/or oligomers of the invention comprise Compound B. In one embodiment, the synthetic antimicrobial polymers and/or oligomers of the invention comprise Compound C. In one embodiment, the synthetic antimicrobial polymers and/or oligomers of the invention comprise Compound D. In some embodiments, the synthetic antimicrobial polymers and/or oligomers of the invention comprise a mixture of Compound A, Compound B, Compound C, and/or Compound D.

In some embodiments, the one or more sesquiterpenoid compounds are selected from nerolidol, farnesol, bisabolol, and apritone, or any mixture thereof. In some embodiments, the sesquiterpenoid compound is nerolidol. In some embodiments, the sesquiterpenoid compound is farnesol. In some embodiments, the sesquiterpenoid compound is bisabolol. In some embodiments, the sesquiterpenoid compound is apritone.

The present invention also provides methods of reducing growth of a microbe comprising contacting the microbe with a composition of the invention, such as those described above. In some embodiments, the microbe is selected from a bacteria, a yeast, a mold, or a fungus. In some embodiments, the bacteria is a Gram positive bacteria. In some embodiments, the bacteria is a Gram negative bacteria. In some embodiments, the microbe is present on the skin of an animal. In some embodiments, the composition is applied to a hard or soft surface. In some embodiments, the hard or soft surface is a food, sink, sponge, or bathroom fixture.

### DESCRIPTION OF EMBODIMENTS

The present invention provides antimicrobial compositions comprising one or more synthetic antimicrobial polymers and/or oligomers and one or more sesquiterpenoid compounds, as well as a carrier. The present invention also provides methods of reducing the growth of a microbe comprising contacting the microbe with a composition of the invention.

Microbes include, for example, bacteria (Gram positive and Gram negative), fungi, yeast, and mold. The compositions of the present invention can be used to kill or inhibit the growth of any of the following microbes or mixtures of the following microbes, or, alternatively, can be administered to treat local and/or systemic microbial infections or illnesses caused by the following microbes or mixtures of the following microbes: Gram-positive cocci, for example Staphylococci (Staph. aureus, Staph. epidermidis) and Streptococci (Strept. agalactiae, Strept. faecalis, Strept. pneumoniae, Strept. pyogenes); Gram-negative cocci (Neisseria gonoirhoeae and Yersinia pestis) and Gram-negative rods such as Enterobacteriaceae, for example Escherichia coli, Hamophilus influenzae, Citrobacter (Citrob. freundii, Citrob. divernis), Salmonella and Shigella, and Francisella (Francisella tularensis); Gram-positive rods such as Bacillus (Bacillus anthracis, Bacillus thuringenesis); furthermore Klebsiella (Klebs. pneumoniae, Klebs. oxytoca), Enterobacter (Ent. aerogenes, Ent. agglomerans), Hafnia, Serratia (Serr. marcescens), Proteus (Pr. mirabilis, Pr. rettgeri, Pr. vulgaris), Providencia, Yersinia, and the genus Acinetobacter. Furthermore, the antimicrobial spectrum of the polymers and/or oligomers of the present invention covers the genus Pseudomonas (Ps. aeruginosa, Ps. maltophilia) and strictly anaerobic bacteria such as, for example, Bacteroides fragilis, representatives of the genus Peptococcus, Peptostreptococcus and the genus Clostridium; furthermore Mycoplasmas (M. pneumoniae, M. hominis, Ureaplasma urealyticum) as well as Mycobacteria, for example Mycobacterium tuberculosis. This list of microbes is purely illustrative and is in no way to be interpreted as restrictive.

Examples of microbial infections or illness that can be treated by administration of the composition of the present invention include, but are not limited to, microbial infections or illnesses in humans such as, for example, otitis, pharyngitis, pneumonia, peritonitis, pyelonephritis, cystitis, endocarditis, systemic infections, bronchitis (acute and chronic), septic infections, illnesses of the upper airways, diffuse panbronchiolitis, pulmonary emphysema, dysentery, enteritis, liver abscesses, urethritis, prostatitis, epididymitis, gastrointestinal infections, bone and joint infections, cystic fibrosis, skin infections, postoperative wound infections, abscesses, phlegmon, wound infections, infected burns, burns, infections in the mouth (including, e.g., but not limited to, periodontal disease and gingivitis), infections after dental operations, osteomyelitis, septic arthritis, cholecystitis, peritonitis with appendicitis, cholangitis, intraabdominal abscesses, pancreatitis, sinusitis, mastoiditis, mastitis, tonsileitis, typhoid, meningitis and infections of the nervous system, salpingitis, endometritis, genital infections, pelveoperitonitis and eye infections.

Examples of viral infections that can be treated by administration of the polymers and/or oligomers of the present invention include, but are not limited to, viral infections caused by human immunodeficiency virus (HIV-1, HIV-2), hepatitis virus (e.g., hepatitis A, hepatitis B, hepatitis C, hepatitis D, and hepatitis E viruses), herpesviruses (e.g. herpes simplex virus types 1 and 2, varicella-zoster virus, cytomegalovirus, Epstein Barr virus, and human herpes viruses types 6, 7, and 8), influenza virus, respiratory syncytial virus (RSV), vaccinia virus, and adenoviruses. This list is purely illustrative and is in no way to be interpreted as restrictive.

Examples of fungal infections or illnesses that can be treated by administration of the compositions of the present invention include, but are not limited to, fungal infections caused by Chytridiomycetes, Hyphochrytridiomycetes, Plasmodiophoromycetes, Oomycetes, Zygomycetes, Ascomycetes, and Basidiomycetes. Fungal infections which can be inhibited or treated with compositions of the polymers and/or oligomers provided herein include, but are not limited to: Candidiasis, including, but not limited to, onchomycosis, chronic mucocutaneous candidiasis, oral candidiasis, epiglottistis, esophagitis, gastrointestinal infections, genitourinary infections, for example, caused by any Candida species, including, but not limited to, Candida albicans, Candida tropicalis, Candida (Torulopsis) glabrata, Candida parapsilosis, Candida lusitaneae, Candida rugosa and Candida pseudotropicalis; Aspergillosis, including, but not limited to, granulocytopenia caused, for example, by, Aspergillus spp. Including, but not limited, to Aspergillus fumigatus, Aspergillus favus, Aspergillus niger and Aspergillus terreus; Zygomycosis, including, but not limited to, pulmonary, sinus and rhinocerebral infections caused by, for example, zygomycetes such as Mucor, Rhizopus spp., Absidia, Rhizomucor, Cunningamella, Saksenaea, Basidobolus and Conidobolus; Cryptococcosis, including, but not limited, to infections of the central nervous system, e.g., meningitis, and infections of the respiratory tract caused by, for example, Cryptococcus neoformans; Trichosporonosis caused by, for example, Trichosporon beigelii; Pseudallescheriasis caused by, for example, Pseudallescheria boydii; Fusarium infection caused by, for example, Fusarium such as Fusarium solani, Fusarium moniliforme and Fusarium proliferartum; and other infections such as those caused by, for example, Penicillium spp. (generalized subcutaneous abscesses), Trichophyton spp., for example, Trichophyton mentagrophytes and Trichophyton rubrum, Stachybotrys spp., for example, S. chartarum, Drechslera, Bipolaris, Exserohilum spp., Paecilomyces lilacinum, Exophila jeanselmei (cutaneous nodules), Malassezia furfur (folliculitis), Alternaria (cutaneous nodular lesions), Aureobasidium pullulans (splenic and disseminated infection), Rhodotorula spp. (disseminated infection), Chaetomium spp. (empyema), Torulopsis candida (fungemia), Curvularia spp. (nasopharnygeal infection), Cunninghamella spp. (pneumonia), H. Capsulatum, B. dermatitidis, Coccidioides immitis, Sporothrix schenckii and Paracoccidioides brasiliensis, Geotrichum candidum (disseminated infection). The compositions of the present invention can also be used to kill or inhibit the growth of any of the fungi listed above. This list is purely illustrative and is in no way to be interpreted as restrictive.

The compositions of the present invention can be administered to a human subject. Thus, in some aspects of the invention, the compositions are administered to a human.

The methods disclosed above also have veterinary applications and can be used to treat a wide variety of non-human vertebrates. Thus, in other aspects of the invention, the compositions of the present invention are administered in the above methods to non-human vertebrates, such as wild, domestic, or farm animals, including, but not limited to, cattle, sheep, goats, pigs, dogs, cats, and poultry such as chicken, turkeys, quail, pigeons, ornamental birds and the like.

The following are examples of microbial infections in non-human vertebrates that can be treated by administering a composition of the present invention: Pig: coli diarrhoea, enterotoxaemia, sepsis, dysentery, salmonellosis, metritis-mastitis-agalactiae syndrome, mastitis; ruminants (cattle, sheep, goat): diarrhoea, sepsis, bronchopneumonia, salmonellosis, pasteurellosis, mycoplasmosis, genital infections; horse: bronchopneumonias, joint ill, puerperal and post-puerperal infections, salmonellosis; dog and cat: bronchopneumonia, diarrhoea, dermatitis, otitis, urinary tract infections, prostatitis; poultry (chicken, turkey, quail, pigeon, ornamental birds and others): mycoplasmosis, E. coli infections, chronic respiratory tract illnesses, salmonellosis, pasteurellosis, psittacosis. This list is purely illustrative and is in no way to be interpreted as restrictive.

Synthetic Antimicrobial Polymers and/or Oligomers

The present invention discloses compositions comprising amphiphilic polymers and/or oligomers. Polymers and/or oligomers are generally defined as synthetic compounds assembled from monomer subunits and are polydisperse in molecular weight. Polymers and/or oligomers are most commonly prepared by one-pot synthetic procedures. The term “polymer and/or oligomer,” as used herein, refers to a macromolecule comprising a plurality of repeating monomers or monomer units. The term “polymer and/or oligomer” can include homopolymers, which are formed from a single type of monomer, and co-polymers, which are formed from two or more different monomers. The term “copolymer” includes polymers and/or oligomers in which the monomers are distributed randomly (random copolymer), in alternating fashion (alternating copolymers), or in blocks (block copolymer).

The synthetic antimicrobial polymers and/or oligomers of the invention are generally low molecular weight polymers having broad spectrum antimicrobial activity. The compositions of the invention can comprise a single synthetic antimicrobial polymer and/or oligomer or a plurality of synthetic antimicrobial polymers. In one embodiment, the synthetic antimicrobial polymers and/or oligomers of the invention are selected from a compound of formula A-(B)ₙ-(D)ₘ-H, or an acceptable salt or solvate thereof, wherein:

A is the residue of a chain transfer agent;

B is —[CH₂—C(R¹¹)(B₁₁)]—, wherein B₁₁ is -X₁₁, -Y₁₁-Z₁₁ and

X₁₁ is carbonyl or optionally substituted C₁₋₆ alkylene; or X₁₁ is absent;

Y₁₁ is O, NH, or optionally substituted C₁₋₆ alkylene; or Y₁₁ is absent

Z₁₁ is Z_{11A}-Z_{11B}, wherein:

Z_{11A} is alkylene, arylene, or heteroarylene, any of which is optionally substituted; or Z_{11A} is absent;

Z_{11B} is -guanidino, -amindino, —N(R³)(R⁴) or —N+(R³)(R⁴)(R⁵), wherein R³, R⁴, and R⁵, are independently hydrogen, alkyl, aminoalkyl, aryl, heteroaryl, heterocyclic, or aralkyl;

D is —[CH₂—C(R²¹)(D₂₁)]-, wherein D₂₁ is -X₂₁-Y₂₁-Z₂₁, and

X₂₁ is carbonyl or optionally substituted C₁₋₆ alkylene; or X₂₁ is absent;

Y₂₁ is O, NH, or optionally substituted C₁₋₆ alkylene; or Y₂₁ is absent;

Z₂₁ is alkyl, cycloakyl, alkoxy, aryl, or aralkyl, any of which is optionally substituted;

R¹¹ and R²¹ are independently hydrogen or C₁₋₄ alkyl;

m, the mole fraction of D monomer, is about 0.1 to about 0.9; and

n, the mole fraction of B monomer is 1-m;

wherein the compound is a copolymer of B and D monomers.

The synthetic antimicrobial polymers and/or oligomers of the composition can be synthesized using a chain transfer agent to control the degree of polymerization and, accordingly, have average degrees of polymerization and average molecular weights that are lower than those of polymers and/or oligomers synthesized without a chain transfer agent. In some embodiments, the synthetic antimicrobial polymers and/or oligomers of the composition have a molecular weight from about 2,000 Daltons to about 15,000 Daltons. In some embodiments, the synthetic antimicrobial polymers and/or oligomers of the composition have a molecular weight from about 2,000 Daltons to about 3,000 Daltons. In some embodiments, the synthetic antimicrobial polymers and/or oligomers of the composition have a molecular weight from about 3,000 Daltons to about 4,000 Daltons. In some embodiments, the synthetic antimicrobial polymers and/or oligomers of the composition have a molecular weight from about 4000 Daltons to about 5,000 Daltons. In some embodiments, the synthetic antimicrobial polymers and/or oligomers of the composition have a molecular weight from about 5000 Daltons to about 6,000 Daltons. In some embodiments, the synthetic antimicrobial polymers and/or oligomers of the composition have a molecular weight from about 6,000 Daltons to about 7,000 Daltons. In some embodiments, the synthetic antimicrobial polymers and/or oligomers of the composition have a molecular weight from about 7,000 Daltons to about 8,000 Daltons. In some embodiments, the synthetic antimicrobial polymers and/or oligomers of the composition have a molecular weight from about 8,000 Daltons to about 9,000 Daltons. In some embodiments, the synthetic antimicrobial polymers and/or oligomers of the composition have a molecular weight from about 9,000 Daltons to about 10,000 Daltons. In some embodiments, the synthetic antimicrobial polymers and/or oligomers of the composition have a molecular weight from about 10,000 Daltons to about 11,000 Daltons. In some embodiments, the synthetic antimicrobial polymers and/or oligomers of the composition have a molecular weight from about 11,000 Daltons to about 12,000 Daltons.

Use of a chain transfer agent to control the degree of polymerization results in the preparation of the low molecular weight the synthetic antimicrobial polymers and/or oligomers of the present invention at relatively high yields and avoids the necessity of time-intensive fractionation by column chromatography, which is usually required to obtain, low molecular weight polymers and/or oligomers in polymerizations performed without a chain transfer agent. The synthetic antimicrobial polymers and/or oligomers of the composition are thus easy to prepare, inexpensive, and suitable for industrial-scale production.

In some embodiments of the invention, the synthetic antimicrobial polymers and/or oligomers of the composition can be synthesized using a chain transfer agent A where A is a residue of a thiol chain transfer agent, including, but not limited to, a residue of any one of the following thiol chain transfer agents:

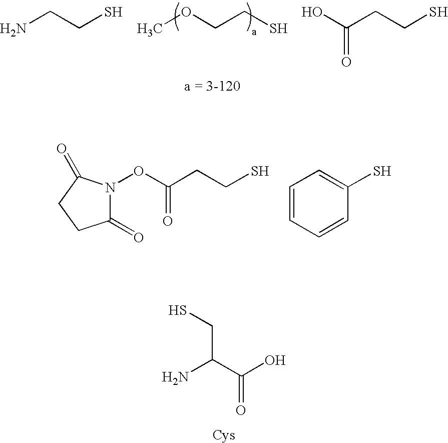

or an alkoxycarbonylalkylhiol, such as methyl 3-mercaptopropinoate and ethyl 3-mercaptopropinoate.

In some embodiments of the invention, the synthetic antimicrobial polymers and/or oligomers are selected from polymethcrylates. In some embodiments of the invention, the synthetic antimicrobial polymers and/or oligomers are selected from polymethcrylates that comprise a first monomer and a second monomers; wherein said first monomer comprises amino-ethyl methacrylate and said second monomer comprises butyl-methacrylate, ethyl-methacrylate, or methyl-methacrylate.

In some embodiments of the invention, the synthetic antimicrobial polymers and/or oligomers compounds are selected from Compound A, Compound B, Compound C, Compound D, or a mixture thereof.

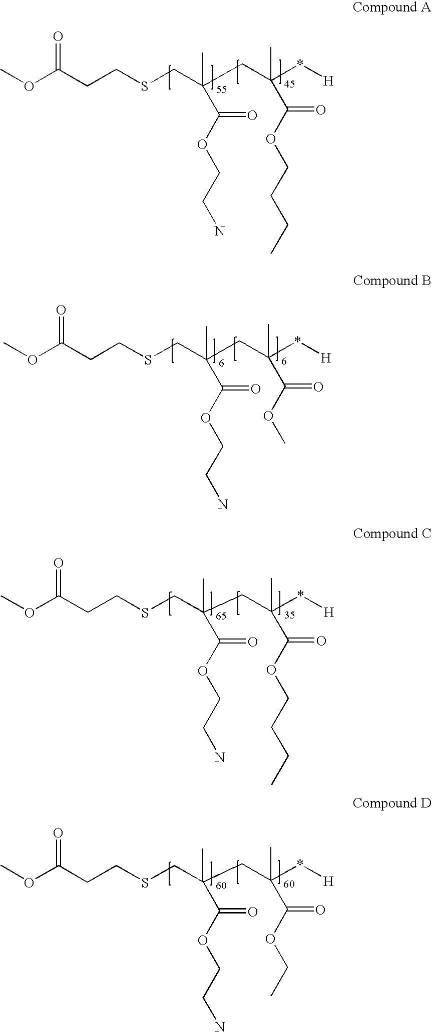

In one embodiment, the synthetic antimicrobial polymers and/or oligomers compounds of the invention comprise Compound A. In one embodiment, the synthetic antimicrobial polymers and/or oligomers compounds of the invention comprise Compound B. In one embodiment, the synthetic antimicrobial polymers and/or oligomers compounds of the invention comprise Compound C. In one embodiment, the synthetic antimicrobial polymers and/or oligomers compounds of the invention comprise Compound D. In some embodiments, the synthetic antimicrobial polymers and/or oligomers compounds of the invention comprise a mixture of Compound A, Compound B, Compound C, and/or Compound D.

### Sesquiterpenoid Compounds

Sesquiterpenoid compounds contain 15 carbons and are formed biosynthetically from condensation of three 5-carbon isoprene units. The compositions of the invention can comprise a single sesquiterpenoid compound or a plurality of sesquiterpenoid compounds. In one embodiment, the composition comprises one or more sesquiterpenoid compounds selected from nerolidol, farnesol, bisabolol, and apritone, or any mixture thereof.

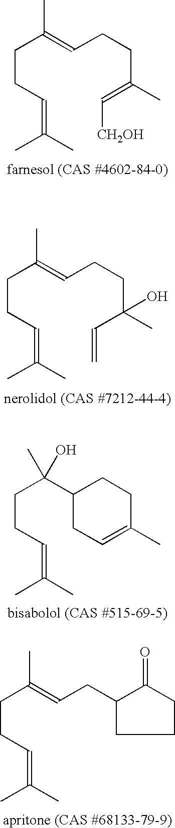

In some embodiments, the composition comprises either nerolidol or farnesol. In some embodiments, the composition comprises nerolidol. In some embodiments, the composition comprises farnesol. In some embodiments, the composition comprises bisabolol. In some embodiments, the composition comprises apritone.

These compounds may be derived from natural sources (i.e., plant essential oils) or formed synthetically, may be cyclic or acyclic and may contain an oxygen atom. The amount of sesquiterpenoid effective for enhancing the antimicrobial activity of the synthetic antimicrobial polymers and/or oligomers of the invention can vary over a wide range such as, for example, from about 0.1 mM to about 50 mM, or from about 0.5 mM to about 2 mM.

### Compositions

The compositions of the invention can be formulated for non-animal use or for animal use. The compositions of the invention also include an acceptable carrier such as, for example, an organic solvent or water. Suitable carriers also include ethanol and propylene glycol, and the like. Additional suitable carriers are well known to the skilled artisan. When the composition is intended to be contacted with an animal, such as a human, the carrier is a pharmaceutically acceptable carrier.

The synthetic antimicrobial polymers and/or oligomers and sesquiterpenoid compounds of the invention may be admixed, encapsulated, conjugated, or otherwise associated with other molecules, such as for example, liposomes, receptor targeted molecules, oral, rectal, topical or other formulations, for assisting in uptake, distribution and/or absorption.

The present invention also includes pharmaceutical compositions and formulations which include the synthetic antimicrobial polymers and/or oligomers and sesquiterpenoid compounds of the invention. The pharmaceutical compositions of the present invention may be administered in a number of ways depending upon whether local or systemic treatment is desired and upon the area to be treated. Administration may be topical, pulmonary, oral, or parenteral.

Pharmaceutical compositions and formulations for topical administration may include transdermal patches, ointments, lotions, creams, gels, drops, suppositories, sprays, liquids and powders. Conventional pharmaceutical carriers, aqueous, powder or oily bases, thickeners and the like may be necessary or desirable. Suitable topical formulations include those in which the synthetic antimicrobial polymers and/or oligomers and sesquiterpenoid compounds of the invention are in admixture with a topical delivery agent such as lipids, liposomes, fatty acids, fatty acid esters, steroids, chelating agents, and/or surfactants. Suitable lipids and liposomes include neutral (e.g. dioleoylphosphatidyl DOPE ethanolamine, dimyristoylphosphatidyl choline DMPC, distearolyphosphatidyl choline) negative (e.g. dimyristoylphosphatidyl glycerol DMPG) and cationic (e.g. dioleoyltetramethylaminopropyl DOTAP and dioleoylphosphatidyl ethanolamine DOTMA). Synthetic antimicrobial polymers and/or oligomers and sesquiterpenoid compounds of the invention may be encapsulated within liposomes or may form complexes thereto, in particular to cationic liposomes. Alternatively, synthetic antimicrobial polymers and/or oligomers and sesquiterpenoid compounds may be complexed to lipids, in particular to cationic lipids. Suitable fatty acids and esters include, but are not limited to, arachidonic acid, oleic acid, eicosanoic acid, lauric acid, caprylic acid, capric acid, myristic acid, palmitic acid, stearic acid, linoleic acid, linolenic acid, dicaprate, tricaprate, monoolein, dilaurin, glyceryl 1-monocaprate, 1-dodecylazacycloheptan-2-one, an acylcarnitine, an acylcholine, or a C₁₋₁₀ alkyl ester (e.g. isopropylmyristate IPM), monoglyceride, diglyceride or a pharmaceutically acceptable salt thereof.

The compositions of the present invention, which may conveniently be presented in unit dosage form, may be prepared according to conventional techniques well known in the industry. Such techniques include the step of bringing into association the active ingredients with the carrier(s) or excipient(s). In general, the compositions are prepared by uniformly and intimately bringing into association the active ingredients with liquid carriers or finely divided solid carriers or both, and then, if necessary, shaping the product.

The compositions of the present invention may be formulated into any of many possible dosage forms such as, but not limited to, tablets, capsules, gel capsules, liquid syrups, soft gels, suppositories, and enemas. The compositions of the present invention may also be formulated as suspensions in aqueous, non-aqueous, or mixed media. Aqueous suspensions may further contain substances which increase the viscosity of the suspension including, for example, sodium carboxymethylcellulose, sorbitol and/or dextran. The suspension may also contain stabilizers.

In one embodiment of the present invention, the compositions may be formulated and used as foams. Pharmaceutical foams include formulations such as, but not limited to, emulsions, microemulsions, creams, jellies and liposomes. While basically similar in nature these formulations vary in the components and the consistency of the final product. The preparation of such compositions and formulations is generally known to those skilled in the pharmaceutical and formulation arts and may be applied to the formulation of the compositions of the present invention.

The compositions of the present invention may additionally contain other adjunct components conventionally found in pharmaceutical compositions, at their art-established usage levels. Thus, for example, the compositions may contain additional, compatible, pharmaceutically-active materials such as, for example, antipruritics, astringents, local anesthetics or anti-inflammatory agents, or may contain additional materials useful in physically formulating various dosage forms of the compositions of the present invention, such as dyes, flavoring agents, preservatives, antioxidants, opacifiers, thickening agents and stabilizers. However, such materials, when added, should not unduly interfere with the biological activities of the components of the compositions of the present invention. The formulations can be sterilized and, if desired, mixed with auxiliary agents, e.g., lubricants, preservatives, stabilizers, wetting agents, emulsifiers, salts for influencing osmotic pressure, buffers, colorings, flavorings and/or aromatic substances and the like which do not deleteriously interact with the compounds of the composition.

One suitable mode of administration is to a skin surface via a topical route. One skilled in the art may use the methods and compositions of the present invention to treat surface wounds or as a general antibacterial treatment. For example, one may desire to prevent sepsis or treat infections. The compositions are preferably topically applied in the form of a lotion, solution, cream, ointment or powder. For treatment of sepsis or intestinal infections, oral or injectable formulations could be employed.

For example, the composition may be formulated into a cream consisting of an aqueous emulsion of polyethylene glycols or liquid paraffin or may be incorporated at a concentration between 1 and 10% into an ointment consisting of a white wax or white soft paraffin base together with such stabilizers and preservatives as may be required. The topical compositions can contain additional ingredients such as binders, excipients, antioxidants, and dyes.

In another mode of administration of the present invention, one may desire to treat hard or soft surfaces, such as tables, cutting surfaces, bathroom fixtures, showers, tubs, sponges, shower curtains, plumbing fixtures, cutlery, and/or sinks with a solution comprising a sesquiterpenoid and a synthetic antimicrobial polymer and/or oligomer. The composition can be applied in the form of a solution to be sprayed or wiped on the surface.

One skilled in the art may also desire to treat the surface of foods in the method of the present invention to reduce microbial growth.

Thus, as discussed above, the present invention also provides methods of reducing growth of a microbe comprising contacting the microbe with a composition of the invention.

In one embodiment of the present invention, the method involves a topical application of the sesquiterpenoid and synthetic antimicrobial polymer and/or oligomer to human or animal skin. For example, one skilled in the art can apply a cream or ointment comprising the sesquiterpenoid and synthetic antimicrobial polymer and/or oligomer to a wound.

In another embodiment, the present invention is the application of the sesquiterpenoid and synthetic antimicrobial polymer and/or oligomer to a hard or soft surface, such as a food, sink, sponge or bathroom fixture.

In another embodiment, the methods of the present invention involve exposing microbes to a mixture comprising a sesquiterpenoid and synthetic antimicrobial polymer and/or oligomer. However, in another embodiment, either the sesquiterpenoid or the synthetic antimicrobial polymer and/or oligomer may be first exposed to the microorganism. In some embodiments, the sesquiterpenoid is administered first.

The formulation of compositions and their subsequent administration (whether to non-animals; or to animals—dosing) is believed to be within the skill of those in the art. Dosing is dependent on severity and responsiveness of the disease state to be treated, with the course of treatment lasting from several days to several months, or until a cure is effected or a diminution of the disease state is achieved. Optimal dosing schedules can be calculated from measurements of drug accumulation in the body of the patient. Persons of ordinary skill can easily determine optimum dosages, dosing methodologies and repetition rates. Optimum dosages may vary depending on the relative potency of particular combinations of sesquiterpenoids and synthetic antimicrobial polymers and/or oligomers, and can generally be estimated based on EC50s found to be effective in in vitro and in vivo animal models. In general, dosage is from 0.01 μg to 100 g per kg of body weight, from 0.11 g to 10 g per kg of body weight, from 1.0 μg to 1 g per kg of body weight, from 10.0 μg to 100 mg per kg of body weight, from 100 μg to 10 mg per kg of body weight, or from 1 mg to 5 mg per kg of body weight and may be given once or more daily, weekly, monthly or yearly. Persons of ordinary skill in the art can easily estimate repetition rates for dosing based on measured residence times and concentrations of the drug in bodily fluids or tissues. Following successful treatment, it may be desirable to have the patient undergo maintenance therapy to prevent the recurrence of the disease state, wherein the sesquiterpenoid and synthetic antimicrobial polymer and/or oligomer is administered in maintenance doses, ranging from 0.01 μg to 100 g per kg of body weight, once or more daily.

Suitable uses include, for example, 1: pre-operative antimicrobial skin washes; 2) topical anti-infectives; 3) biocidal treatments for controlling microbial growth in industrial environments; 4) decontamination solutions intended for containment and remediation of biological threats; and 5) medical devices such as, for example, contact lenses.

The term “copolymer backbone” or “backbone” as used herein refers to that portion of the copolymer which is a continuous chain comprising the bonds formed between monomers upon polymerization. The composition of the copolymer backbone can be described in terms of the identity of the monomers from which it is formed without regard to the composition of branches, or side chains, of the copolymer backbone.

The term “copolymer side chain” or “side chain” refers to portions of the monomer which, following polymerization, forms an extension of the copolymer backbone.

The term “amphiphilic” as used herein describes a structure having discrete hydrophobic and hydrophilic regions. An amphiphilic copolymer requires the presence of both hydrophobic and hydrophilic elements along the copolymer backbone.

The term “microorganism” as used herein includes bacteria, algae, fungi, yeast, mycoplasmas, mycobacteria, parasites and protozoa.

The term “antimicrobial,” “microbiocidal,” or “biocidal” as used herein means that the materials inhibit, prevent, or destroy the growth or proliferation of microorganisms. This activity can be either bacteriocidal or bacteriostatic. The term “bactoriocidal” as used herein means the killing of microorganisms. The term “bacteriostatic” as used herein refers to inhibiting the growth of microorganisms which can be reversible under certain conditions.

The term “alkyl” as used herein by itself or as part of another group refers to both straight and branched-chain aliphatic hydrocarbon radicals from 1 to 12 carbons, such as methyl, ethyl, propyl, isopropyl, butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl.

The term “alkylene” as used herein refers to straight chain or branched divalent aliphatic hydrocarbon radicals from 1 to 20 carbon atoms in length, or, more preferably, from 1 to 10 carbon atoms, or from 1 to 6 carbon atoms in length. Examples of alkylene radicals include, but are not limited to, methylene (—CH₂—), ethylene (—CH₂CH₂—), propylene isomers (e.g., —CH₂CH₂CH₂— and —CH(CH₃)CH₂—), and the like.

The term “alkoxy” as used herein refers to a straight or branched chain aliphatic hydrocarbon radicals of 1 to 20 carbon atoms, unless the chain length is limited thereto, bonded to an oxygen atom, including, but not limited to, methoxy, ethoxy, n-propoxy, isopropoxy, and the like. Preferably, the alkoxy chain is 1 to 10 carbon atoms in length, more preferably 1 to 8 carbon atoms in length, and even more preferred 1 to 6 carbon atoms in length.

The term “aryl” as used herein by itself or as part of another group refers to monocyclic or bicyclic aromatic groups containing from 6 to 12 carbons in the ring portion, preferably 6-10 carbons in the ring portion, such as the carbocyclic groups phenyl, naphthyl and tetrahydronaphthyl.

The term “arylene” as used herein refers to divalent aryl groups (e.g., monocyclic or bicyclic aromatic groups) containing from 6 to 12 carbons in the ring portion, preferably 6-10 carbons in the ring portion, that are derived from removal of a hydrogen atom from two ring carbon atoms. Examples of arylene groups include, but are not limited to o-phenylene, naphthylene, benzene-1,2-diyl and the like.

The term “cycloalkyl” as used herein by itself or as part of another group refers to cycloalkyl groups containing 3 to 9 carbon atoms, more preferably, 3 to 8 carbon atoms. Typical examples are cyclopropyl, cyclobutyl, cyclopentyl, cyclohexyl, cycloheptyl, cyclooctyl and cyclononyl.

The term “halogen” or “halo” as used herein by itself or as part of another group refers to chlorine, bromine, fluorine or iodine.

The term “heteroaryl” as used herein refers to groups having 5 to 14 ring atoms; 6, 10 or 14 7π-electrons shared in a cyclic array; and containing carbon atoms and 1, 2 or 3 oxygen, nitrogen or sulfur heteroatoms. Examples of heteroaryl groups include thienyl, imadizolyl, oxadiazolyl, isoxazolyl, triazolyl, pyridyl, pyrimidinyl, pyridazinyl, furyl, pyranyl, thianthrenyl, pyrazolyl, pyrazinyl, indolizinyl, isoindolyl, isobenzofuranyl, benzoxazolyl, xanthenyl, 2H-pyrrolyl, pyrrolyl, 3H-indolyl, indolyl, indazolyl, purinyl, 4H-quinolizinyl, isoquinolyl, quinolyl, phthalazinyl, naphthyridinyl, quinazolinyl, phenanthridinyl, acridinyl, perimidinyl, phenanthrolinyl, phenazinyl, isothiazolyl, phenothiazinyl, isoxazolyl, furazanyl, and phenoxazinyl groups. Especially preferred heteroaryl groups include 1,2,3-triazole, 1,2,4-triazole, 5-amino 1,2,4-triazole, imidazole, oxazole, isoxazole, 1,2,3-oxadiazole, 1,2,4-oxadiazole, 3-amino-1,2,4-oxadiazole, 1,2,5-oxadiazole, 1,3,4-oxadiazole, pyridine, and 2-aminopyridine. The term “heteroarylene” as used herein refers to divalent heteroaryl groups that are derived from removal of a hydrogen atom from two ring atoms.

The term “heterocycle,” “heterocyclic,” or “heterocyclic ring”, as used herein except where noted, represents a stable 5- to 7-membered mono- or bicyclic or stable 7- to 10-membered bicyclic heterocyclic ring system any ring of which may be saturated or unsaturated, and which consists of carbon atoms and from one to three heteroatoms selected from the group consisting of N, O and S, and wherein the nitrogen and sulfur heteroatoms may optionally be oxidized, and the nitrogen heteroatom may optionally be quaternized, and including any bicyclic group in which any of the above-defined heterocyclic rings is fused to a benzene ring. Especially useful are rings containing one oxygen or sulfur, one to three nitrogen atoms, or one oxygen or sulfur combined with one or two nitrogen atoms. The heterocyclic ring may be attached at any heteroatom or carbon atom which results in the creation of a stable structure. Examples of such heterocyclic groups include piperidinyl, piperazinyl, 2-oxopiperazinyl, 2-oxopiperidinyl, 2-oxopyrrolodinyl, 2-oxoazepinyl, azepinyl, pyrrolyl, 4-piperidonyl, pyrrolidinyl, pyrazolyl, pyrazolidinyl, imidazolyl, imidazolinyl, imidazolidinyl, pyridyl, pyrazinyl, pyrimidinyl, pyridazinyl, oxazolyl, oxazolidinyl, isoxazolyl, isoxazolidinyl, morpholinyl, thiazolyl, thiazolidinyl, isothiazolyl, quinuclidinyl, isothiazolidinyl, indolyl, quinolinyl, isoquinolinyl, benzimidazolyl, thiadiazoyl, benzopyranyl, benzothiazolyl, benzoxazolyl, furyl, tetrahydrofuryl, tetrahydropyranyl, thienyl, benzothienyl, thiamorpholinyl, thiamorpholinyl sulfoxide, thiamorpholinyl sulfone, and oxadiazolyl. Morpholino is the same as morpholinyl.

The term “alkylamino” as used herein by itself or as part of another group refers to an amino group which is substituted with one alkyl group having from 1 to 6 carbon atoms. The term “dialkylamino” as used herein by itself or as part of an other group refers to an amino group which is substituted with two alkyl groups, each having from 1 to 6 carbon atoms.

The term “alkylthio” as used herein by itself or as part of an other group refers to an thio group which is substituted with one alkyl group having from 1 to 10 carbon atoms, or, preferably, from 1 to 6 carbon atoms.

Generally and unless defined otherwise, the phrase “optionally substituted” used herein refers to a group or groups being optionally substituted with one or more substituents independently selected from the group consisting of amino, hydroxy, nitro, halogen, cyano, thiol, C₁₋₆ alkyl, C₂₋₆ alkenyl, C₂₋₆ alkynyl, C₃₋₆ cycloalkyl, and C₁₋₆ aryl.

The terms “treat,” “treated,” or “treating” as used herein refers to both therapeutic treatment and prophylactic or preventative measures, wherein the object is to prevent or slow down (lessen) an undesired physiological condition, disorder or disease, or to obtain beneficial or desired clinical results. For the purposes of this invention, beneficial or desired clinical results include, but are not limited to, alleviation of symptoms; diminishment of the extent of the condition, disorder or disease; stabilization (i.e., not worsening) of the state of the condition, disorder or disease; delay in onset or slowing of the progression of the condition, disorder or disease; amelioration of the condition, disorder or disease state; and remission (whether partial or total), whether detectable or undetectable, or enhancement or improvement of the condition, disorder or disease. Treatment includes eliciting a clinically significant response without excessive levels of side effects. Treatment also includes prolonging survival as compared to expected survival if not receiving treatment.

The term “animal” as used herein includes, but is not limited to, humans and non-human vertebrates such as wild, domestic and farm animals.

In order that the invention disclosed herein may be more efficiently understood, examples are provided below. It should be understood that these examples are for illustrative purposes only and are not to be construed as limiting the invention in any manner.

### EXAMPLES

### Chemical Reagents

Farnesol and nerolidol can be obtained from Sigma (St. Louis, Mo.). Apritone and bisabolol can be obtained from Bedoukian Research, Inc. (Danbury, Conn.).

### Bacterial Strains and Growth Conditions

Erwinia sp. #351 can be obtained from Presque Isle Cultures (Presque Isle, Pa.). Lactobacillus fermentum ATCC 14931, Zygosaccharomyces bailii ATCC 60483 and E. coli ATCC 25922 (National Committee on Clinical Laboratory Standards antibiotic test strain) can be obtained from American Type Culture Collection (Manassas, Va.). Staphylococcus aureus ATCC 6538 and Enterococcus faecalis Bact. 4025 can be obtained from the UW-Madison Department of Bacteriology culture collection. All bacteria except for L. fermentum can be grown statically in screwcap tubes containing 10 ml Trypticase Soy Broth (BBL, Cockeysville, Md.) for 20-22 hours at 30° C. L. fermentum can be grown statically in screwcap tubes containing 10 ml MRS broth (Difco) for 20-22 hours at 30° C. Cultures of Z. bailii can be grown in 125 ml culture flasks containing 50 ml YM broth (Difco) on a rotary shaker set at 200 rpm for 20-22 hours at 25° C.

### Antimicrobial Disc Assay

The activity of particular compositions can be assessed using an antibiotic disc assay. For this assay, cells from an overnight growth are suspended to a known concentration in 0.5 ml 67 mM phosphate buffer, pH 7.0 and mixed with 4.5 ml 0.7% Iso-Sensitest agar (Oxoid, Basingstoke, Hampshire, England) overlay tempered to 50° C. Sesquiterpenoid compounds dissolved in absolute ethanol can be added to the cell/agar overlay mixture yielding final concentrations of 0.5, 1.0 or 2.0 mM, depending on the experiment. The final concentration of ethanol in cell overlays can be 0.5% and the final concentration of target cells can be about 10⁶ cfu/ml. After thorough vortexing, sesquiterpenoid-containing cell overlays can be poured over hardened Iso-Sensitest agar (2% agar) plates and allowed to set. Antibiotic discs containing various synthetic antimicrobial polymers and/or oligomers can be placed on the surface of plates containing sesquiterpenoid/cell overlays and plates can be incubated at 37° C. for 22-24 hours. After incubation, zones of inhibition can be measured with a ruler from the bottom of the plates.

### Plating Assay

To assess the effect of sesquiterpenoids on enhancing synthetic antimicrobial polymer and/or oligomer activity against E. coli, cells from an overnight growth can be suspended in 67 mM phosphate buffer to about 10⁷ cfu/ml and treated with either synthetic antimicrobial polymer and/or oligomer alone, sesquiterpenoid alone, or a combination of the two and incubated at 37° C. for up to 30 minutes. After incubation, cells can be enumerated by pour plating in Trypticase Soy agar, tempered to 50° C. Plates can be incubated overnight at 37° C. prior to counting colonies. In some plating assays, D/E neutralizing agar was found to be effective and contained five neutralizers (sodium bisulfite, sodium thioglycollate, sodium thiosulfate, lecithin, and Tween 80).

### Example 1

### Antimicrobial Disc Assays

Sesquiterpenoid-mediated enhancement of Compound D was observed in an antimicrobial disc assay against E. coli and L. innocue (results not shown). Sesquiterpenoid-mediated enhancement of Compound A and Compound C was observed in an antimicrobial disc assay against E. coli (results not shown). Sesquiterpenoid-mediated enhancement of Compound D was also observed in an antimicrobial disc assay against S. typhimurium (results not shown).

In another assay, sesquiterpenoids had no impact on activity of traditional antibiotics (such as, clindamycin, gentamicin, tetracycline, ciprofloxacin, vancomycin, and imipenem) against E. coli, whereas Compound A, Compound C, and Compound D were enhanced (results not shown).

### Example 2

### Plating Assays

In one assay, 15.7 μg/ml of Compound C was required for complete inhibition of E. coli (data not shown). With the addition of nerolidol, as little as 0.5 μg/ml of Compound C was required for complete inhibition of E. coli, demonstration of about a 30-fold enhancement (data not shown).

In another assay, enhancement of Compound A antimicrobial activity with 100 μM Nerolidol was observed for Candida albicans (data not shown).

In another assay, enhancement of Compound C antimicrobial activity with 100 μM Nerolidol was observed for E. coli (data not shown).

In another assay, enhancement of Compound C antimicrobial activity with 100 μM Nerolidol was observed for Enterococcus faecalis (data not shown).

### Example 3

### Minimum Inhibitory Concentration (MIC) Assays

In one assay, the MIC (μg/ml) of synthetic antimicrobial polymer and/or oligomer alone and enhancement in the presence of 100 μM sesquiterpenoids against E. coli ATCC 25922 was determined. Results are shown in Table 1.

TABLE 1

E. coli ATCC 25922

| | | Bisabolol | Farnesol | Nerolidol |
|---|---|---|---|---|
| Compound A | 31.25 | 7.81 | 7.81 | 15.63 |
| Compound C | 31.25 | 1.95 | 1.95 | 1.95 |
| Compound D | 62.5 | 3.91 | 3.91 | 3.91 |

In another assay, the MIC (μg/ml) of synthetic antimicrobial polymer and/or oligomer alone and enhancement in the presence of 100 μM sesquiterpenoids against S. aureus ATCC 29523 was determined. Results are shown in Table 2.

TABLE 2

S. aureus ATCC 29523

| | | Bisabolol | Farnesol | Nerolidol |
|---|---|---|---|---|
| Compound A | 31.25 | 15.63 | 7.81 | 15.63 |
| Compound C | 31.25 | 7.81 | 3.91 | 7.81 |
| Compound D | 62.5 | 15.63 | 3.91 | 7.81 |

### Example 4

### Inactivation Kinetics

In one assay, the effect of E. coli ATCC 25922 viability after exposure to Compound C (31.25 μg/ml) and Nerolidol (200 μM) and enhancement with the combination was determined. Results are shown in Table 3.

TABLE 3

| | Time (min) | | | | | D-value |
|---|---|---|---|---|---|---|
| | 0 | 5 | 10 | 15 | 30 | (min) |
| Compound C | 8.75 | 8.69 | 8.65 | 8.64 | 8.59 | 88.39 |
| Nerolidol | 8.83 | 8.80 | 8.79 | 8.79 | 8.77 | 260.80 |
| Compound C + | 8.21 | 5.42 | 4.85 | 4.12 | 3.99 | 3.92 |
| Nerolidol | | | | | | |

The Decimal log reduction (D-value) was calculated as the time required to provide a one decimal logarithm (1-log 10) or 90% reduction in the initial viable bacterial population. The surviving cell numbers (log₁₀) were plotted against time for each treatment. The average slopes were obtained using linear regression analysis and were used to calculate D-values for each treatment using D=−1/slope.

A three log reduction was observed after only five minutes with the combination of Compound C (31.25 μg/ml) and Nerolidol (200 μM). A five log reduction was observed with the combination after 30 minutes.

Various modifications of the invention, in addition to those described herein, will be apparent to those skilled in the art from the foregoing description. Such modifications are also intended to fall within the scope of the appended claims. Each reference (including, but not limited to, journal articles, U.S. and non-U.S. patents, patent application publications, international patent application publications, and the like) cited in the present application is incorporated herein by reference in its entirety.

What is claimed is:

1. An antimicrobial composition comprising:
one or more synthetic antimicrobial polymers and/or oligomers;
one or more sesquiterpenoid compounds; and
a carrier.

2. A composition according to claim 1 wherein the carrier is selected from water, ethanol, and propylene glycol.

3. A composition according to claim 1 wherein the carrier is a pharmaceutically acceptable carrier.

4. A composition according to claim 1 wherein the one or more synthetic antimicrobial polymers and/or oligomers are polymethacrylate compounds.

5. A composition according to claim 1 wherein the one or more synthetic antimicrobial polymers and/or oligomers are selected from a compound of formula A-(B)ₙ-(D)ₘ-H, or an acceptable salt or solvate thereof, wherein:
A is the residue of a chain transfer agent;
B is —[CH₂—C(R¹¹)(B₁₁)]—, wherein B₁₁ is -X₁₁, -Y₁₁-Z₁₁, and
X₁₁ is carbonyl or optionally substituted C₁₋₆ alkylene; or X₁₁ is absent;
Y₁₁ is O, NH, or optionally substituted C₁₋₆ alkylene; or Y₁₁ is absent
Z₁₁ is Z_{11A}-Z_{11B}, wherein:
Z_{11A} is alkylene, arylene, or heteroarylene, any of which is optionally substituted; or Z_{11A} is absent;
Z_{11B} is -guanidino, -amindino, —N(R³)(R⁴) or —N+(R³)(R⁴)(R⁵), wherein R³, R⁴, and R⁵, are independently hydrogen, alkyl, aminoalkyl, aryl, heteroaryl, heterocyclic, or aralkyl;
D is —[CH₂—C(R²¹)(D₂₁)]-, wherein D₂₁ is -X₂₁-Y₂₁-Z₂₁, and
X₂₁ is carbonyl or optionally substituted C₁₋₆ alkylene; or X₂₁ is absent;
Y₂₁ is O, NH, or optionally substituted C₁₋₆ alkylene; or Y₂₁ is absent;
Z₂₁ is alkyl, cycloakyl, alkoxy, aryl, or aralkyl, any of which is optionally substituted;
R¹¹ and R²¹ are independently hydrogen or C₁₋₄ alkyl;
m, the mole fraction of D monomer, is about 0.1 to about 0.9; and
n, the mole fraction of B monomer is 1-m;
wherein the compound is a copolymer of B and D monomers.

6. A composition according to claim 1 wherein the one or more synthetic antimicrobial polymers and/or oligomers are selected from Compound A, Compound B, Compound C, Compound D, or any mixture thereof.

7. A composition according to claim 1 wherein the one or more synthetic antimicrobial polymers and/or oligomers are Compound A.

8. A composition according to any one of claims 1 to 3 wherein the one or more synthetic antimicrobial polymers and/or oligomers are Compound B.

9. A composition according to any one of claims 1 to 3 wherein the one or more synthetic antimicrobial polymers and/or oligomers are Compound C.

10. A composition according to claim 1 wherein the one or more synthetic antimicrobial polymers and/or oligomers are Compound D.

11. A composition according to claim 1 wherein the one or more sesquiterpenoid compounds are selected from nerolidol, farnesol, bisabolol, and apritone, or any mixture thereof.

12. A composition according to claim 1 wherein the sesquiterpenoid compound is nerolidol.

13. A composition according to claim 1 wherein the sesquiterpenoid compound is farnesol.

14. A composition according to claim 1 wherein the sesquiterpenoid compound is bisabolol.

15. A composition according to claim 1 wherein the sesquiterpenoid compound is apritone.

16. A method of reducing growth of a microbe comprising contacting the microbe with a composition according to claim 1.

17. A method according to claim 16 wherein the microbe is selected from a bacteria, a yeast, a mold, or a fungus.

18. A method according to claim 16 wherein the bacteria is a Gram positive bacteria.

19. A method according to claim 16 wherein the bacteria is a Gram negative bacteria.

20. A method according to claim 16 wherein the microbe is present on the skin of an animal.

21. A method according to claim 16 wherein the composition is applied to a hard or soft surface.

22. A method according to claim 21 wherein the hard or soft surface is a food, sink, sponge, or bathroom fixture.
